(19) United States
(12) Patent Application Publication
(10) Pub. No.: US 2017/0057060 A1
(43) Pub. Date: Mar. 2, 2017

(54) Fill Port Cap Combination Wrench

(71) Applicant: Richard Rudy, Flossmoor, IL (US)

(72) Inventor: Richard Rudy, Flossmoor, IL (US)

(21) Appl. No.: 14/836,071

(22) Filed: Aug. 26, 2015

(51) Int. Cl. B25B 13/50; B67B 7/14; B25B 13/06

(52) U.S. Cl. CPC B25B 13/50; B25B 13/06; B67B 7/14

(57) ABSTRACT

A fill port cap combination wrench designed to facilitate opening, closing, and properly torqueing most six-inch fill port caps on intermediate bulk containers and mini bulk containers. The fill port cap combination wrench includes a flat annular surface adapted to engage tabs on the fill port cap, and a connecting member having a first side and a second side. A first support structure vertically extends from the first side of the connecting member to the flat annular surface and a second support structure vertically extends from the second side of the connecting member to the flat annular surface. The connecting member further includes an aperture, disposed between the first side and the second side, for engaging the drive of a socket wrench or a torque wrench. A handle is included laterally extending from each support structure for manually turning the fill port cap combination wrench.

### BACKGROUND OF THE INVENTION

1. Field of the Invention

The present invention relates to a fill port cap combination wrench, and more particularly, to a fill port cap combination wrench that facilitates opening and closing a six inch fill port cap on intermediate bulk containers and mini bulks.

2. Description of the Prior Art

Intermediate bulk containers (IBCs) and mini bulk containers (MBCs) that carry hazardous products must comply with the U.S. Department of Transportation's (USDOT) closing requirements. The fill port caps on the IBCs and the MBCs must be properly torqued before shipping hazardous products to avoid any fines imposed by the USDOT for non-compliance. The six inch fill port caps are typically hard to turn, which results in a tedious, slow opening and closing process. The fill port cap combination wrench of the present invention allows a user to open and close hard to turn six inch fill port caps quickly and easily.

U.S. Pat. No. 1,207,560 discloses an appliance for receptacle caps or covers that includes a shallow cup-shaped member having corrugations that engage the corrugations on the cap and a hand piece attached to the top of the cup-shaped member for turning the appliance. The appliance in patent '560 does not disclose a wrench that has a flat annular surface, a connecting member disposed above the flat annular surface, or an aperture for engaging a manual socket or torque wrench.

U.S. Pat. No. 5,606,897 discloses an oil filter wrench and packaging that includes a cup-shaped body with a socket and nut. The inner surface of the cup-shaped body includes angled facets for engaging the angled facets of a conventional oil filter. To aid in the manipulation of the oil filter wrench, the nut can be operated by an adjustable wrench and the socket can be operated by a conventional ratchet wrench. The wrench in patent '897 does not disclose a flat annular surface, a connecting member disposed above the flat annular surface, or handles on each side of the connecting member to facilitate manual rotation.

U.S. Pat. No. 8,066,139 discloses a plastic plug that includes a series of projections with an overcap and a wrench. The wrench has a head that includes part-hemispherical recesses that fit securely over the series of projections on the plug. The head also includes a square opening to engage a releasable square drive on a distal end of the wrench handle. The wrench in patent '139 does not disclose a flat annular surface, a connecting member disposed above the flat annular surface, or handles on each side of the connecting member to facilitate manual rotation.

U.S. Patent Application Publication 2008/0083305 discloses a wrench including two channel irons that are positioned to accept a tote cover in between and engaging a plurality of ridges on the tote cover. The wrench also includes a hex head that is connected to the top surface of the main body of the wrench and is located at a center point of the wrench. The hex head engages a torque wrench and is used to torque the tote cover to a specified torque requirement. The wrench in publication '305 does not disclose a flat annular surface including a plurality of notches that engage the plurality of tabs on a fill port cap. The wrench in publication '305 utilizes the channel irons to rotate the tote cover, whereas the fill port cap combination wrench of the present invention utilizes the plurality of notches in the flat annular surface to rotate the fill port cap.

The prior art to date does not disclose a fill port cap combination wrench that is designed to quickly and easily open, close, and properly torque a six inch fill port cap on IBCs and MBCs. None of the prior art can be combined in a way to suggest the necessary modifications to produce the fill port cap combination wrench of the present invention. There is no teaching, suggestion, or motivation that would have enabled a person of ordinary skill in the art to modify any prior art wrench in the manner embodied in the present invention.

It is a primary object of the present invention to provide a fill port cap combination wrench that allows a user to quickly and easily open and close six inch fill port caps.

Another object of the present invention is to provide a fill port cap combination wrench that allows the user to properly torque six inch fill port caps before shipping hazardous products.

Still another object of the present invention is to provide a fill port cap combination wrench that allows users to easily comply with USDOT closing requirements.

Still another object of the present invention is to provide a fill port cap combination wrench that allows users to manually apply force or insert a socket or torque wrench to apply force to the fill port cap combination wrench to open and close the fill port cap.

Still another object of the present invention is to provide a fill port cap combination wrench that is lightweight and easy to handle and carry.

Still another object of the present invention is to provide a fill port cap combination wrench that comprises one piece.

Still another object of the present invention is to provide a fill port cap combination wrench that fits most six inch fill port caps on IBCs and MBCs.

Still another object of the present invention is to provide a fill port cap combination wrench that accepts any half inch drive socket wrench or torque wrench.

### SUMMARY OF THE INVENTION

The fill port cap combination wrench of the present invention is designed to facilitate opening, closing, and properly torqueing most six-inch fill port caps on intermediate bulk containers and mini bulk containers. The fill port cap combination wrench comprises a flat annular surface and a connecting member having a first side and a second side. The connecting member is disposed along a line dissecting the flat annular surface. A first support structure vertically extends from the first side of the connecting member to the flat annular surface and a second support structure vertically extends from the second side of the connecting member to the flat annular surface. The first support structure has a first end that is integrally formed with the first side of the connecting member and a second end that is integrally formed with the flat annular surface. The second support structure has a first end that is integrally formed with the second side of the connecting member and a second end that is integrally formed with the flat annular surface. The connecting member further includes an aperture, disposed between the first side and the second side, for engaging the drive of a socket wrench or a torque wrench. A handle is included laterally extending from each support structure for manually turning the fill port cap combination wrench.

### BRIEF DESCRIPTION OF THE DRAWINGS

The present invention is further described with reference to the accompanying drawings in which:

FIG. 1 is a top perspective view of an embodiment of the fill port cap combination wrench of the present invention.

FIG. 2 is a bottom perspective view of the embodiment of the fill port cap combination wrench of the present invention.

FIG. 3 is a top perspective view of the embodiment of the fill port cap combination wrench of the present invention engaging a six inch fill port cap.

FIG. 4 is a top perspective view of the embodiment of the fill port cap combination wrench of the present invention engaging a six inch fill port cap and a torque wrench.

### DETAILED DESCRIPTION OF THE ILLUSTRATED EMBODIMENTS

The fill port caps on intermediate bulk containers (IBCs) and mini bulk containers (MBCs) that carry hazardous products must be properly torqued to comply with U.S. Department of Transportation closing requirements and avoid non-compliance fines. The six inch fill port caps on IBCs and MBCs are typically hard to turn, which results in a tedious and slow opening and closing process. The fill port cap combination wrench of the present invention allows a user to quickly and easily open, close, and properly torque most six inch fill port caps on IBCs and MBCs.

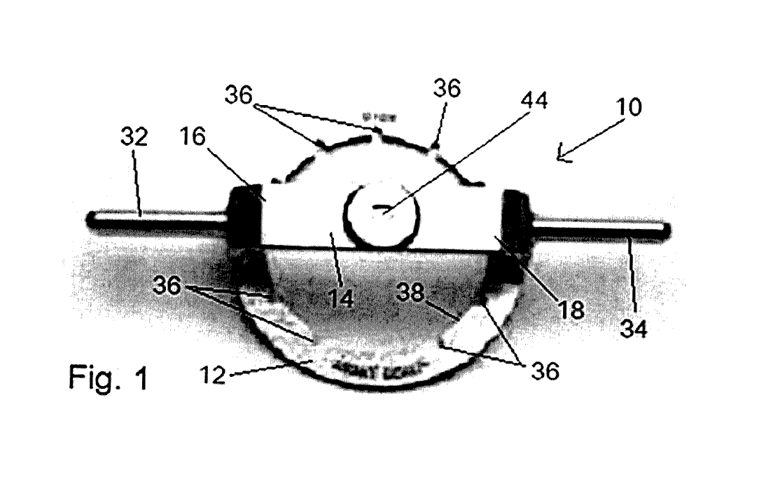

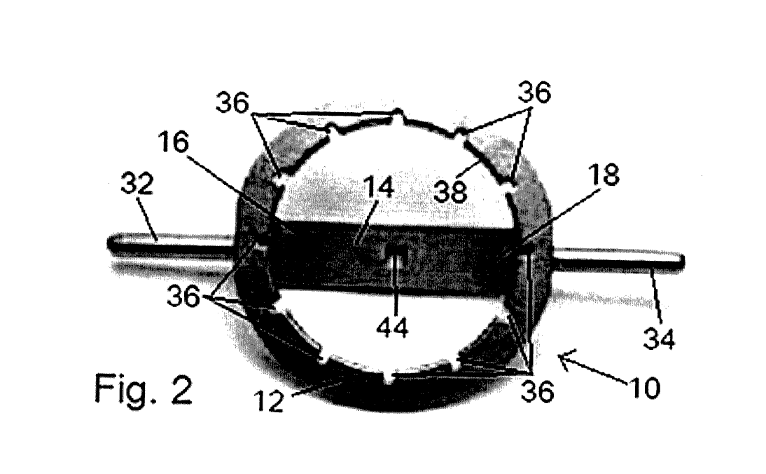

In an illustrated embodiment of the present invention, shown in FIGS. 1-4, the fill port cap combination wrench 10 comprises a flat annular surface 12 and a connecting member 14 disposed a predetermined distance above the flat annular surface 12 and along a line bisecting the flat annular surface 12. The connecting member 14 includes a first side 16 opposite a second side 18. Connecting member 14 further includes an aperture 44 disposed between first side 16 and second side 18. Aperture 44 is designed to engage a half inch drive manual socket wrench or torque wrench 28, shown in FIG. 4, to facilitate rotation of the fill port cap combination wrench 10.

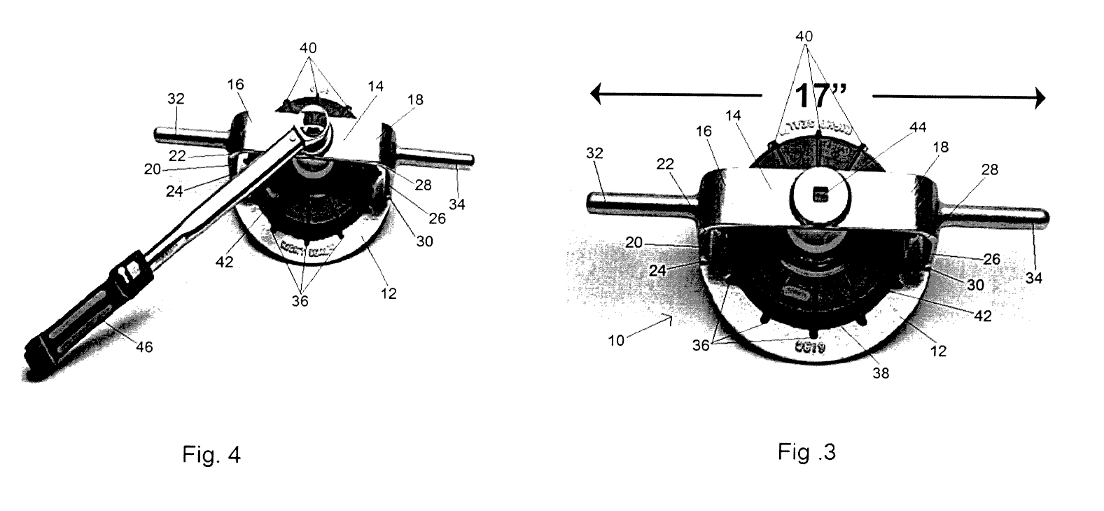

Referring to FIGS. 3 and 4, a first support structure 20 is integrally formed at a first end 22 to first side 16 of connecting member 14 and is integrally formed at a second end 24 to flat annular surface 12. A second support structure 26 is integrally formed at a first end 28 to second side 18 of connecting member 14 and is integrally formed at a second end 30 to flat annular surface 12. First support structure 20 and second support structure 26 are disposed on opposite sides of flat annular surface 12 at opposing ends of the line bisecting the flat annular surface 12 and vertically extend from connecting member 14 to flat annular surface 12.

Handle 32 is integrally formed with first support structure 20 between first end 22 and second end 24. Handle 34 is integrally formed with second support structure 26 between first end 28 and second end 30. Handle 32 laterally extends from first side 16 of connecting member 14 and handle 34 laterally extends from second side 18 of connecting member 14. Handle 32 and handle 34 are disposed on opposite sides of flat annular surface 12 at opposing ends of the line bisecting the flat annular surface 12.

The flat annular surface 12 includes a plurality of notches 36 along the inner circumference 38 of the flat annular surface 12. The plurality of notches 36 are designed to engage a plurality of tabs 40 on a six inch fill port cap 42, shown in FIG. 3, to facilitate rotation of the fill port cap 42.

To open, close, or properly torque a fill port cap 42 on an IBC or MBC, the user places the fill port cap combination wrench 10 onto fill port cap 42, engaging the plurality of notches 36 on the fill port cap combination wrench 10 with the plurality of tabs 40 on fill port cap 42. The user can then manually apply force directly onto handles 32, 34 and rotate fill port cap 42 to open, close, or properly torque fill port cap 42. Alternatively, the user can insert the half inch drive of a manual socket wrench or torque wrench 46 into aperture 44. The half inch drive engages aperture 44 and the user can then apply force to socket wrench or torque wrench 46 to rotate the fill port cap combination wrench 10 and fill port cap 42 to open, close, or properly torque fill port cap 42.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A combination wrench for opening, closing, and torqueing a fill port cap on a container, the combination wrench comprising:
a. a flat annular surface;
b. a connecting member having a first side and a second side, said connecting member disposed along a line dissecting said flat annular surface;
c. a first support structure having a first end and a second end, said first end integrally formed with said first side of said connecting member and said second end integrally formed with said flat annular surface, said first support structure vertically extending from said connecting member to said flat annular surface;
d. a second support structure having a third end and a fourth end, said third end integrally formed with said second side of said connecting member and said fourth end integrally formed with said flat annular surface, said second support structure vertically extending from said connecting member to said flat annular surface; and
e. an inner circumference of said flat annular surface configured to engage a plurality of tabs on the fill port cap.

2. The combination wrench of claim 1, further comprising an aperture disposed between said first side and said second side of said connecting member, said aperture adapted to engage one of a socket wrench and a torque wrench.

3. The combination wrench of claim 1, further comprising:
a. a first handle integrally formed with and laterally extending from said first support structure; and
b. a second handle integrally formed with and laterally extending from said second support structure.

4. The combination wrench of claim 1, wherein the inner circumference of said flat annular surface includes a plurality of notches adapted to engage the plurality of tabs on the fill port cap.
